(19) United States
(12) Patent Application Publication
(10) Pub. No.: US 2015/0186862 A1
(43) Pub. Date: Jul. 2, 2015

(54) INFORMATION PROCESSING APPARATUS, INFORMATION PROCESSING SYSTEM, UNREGISTERED PRODUCT LOOKUP METHOD, AND UNREGISTERED PRODUCT LOOKUP PROGRAM

(71) Applicant: NEC Corporation, Tokyo (JP)

(72) Inventors: Tadashi Itani, Tokyo (JP); Rumi Ikezawa, Tokyo (JP)

(21) Appl. No.: 14/421,511

(22) PCT Filed: Mar. 27, 2013
(86) PCT No.: PCT/JP2013/002080

§ 371 Date: Feb. 13, 2015

(30) Foreign Application Priority Data
Aug. 15, 2012 (JP) 2012-180248

(51) Int. Cl. G06Q 20/20; G06Q 30/00

(52) U.S. Cl. CPC G06Q 20/208; G06Q 30/01

(57) ABSTRACT

An information processing apparatus includes an image acquisition unit (104) that acquires a product image of a product which is captured by an imaging unit and is registered as a checkout target, a request transmitting unit (105) that transmits a product information request including the product image to a clerk terminal (30), and a response receiving unit (108) that receives response information including sale price information of the product which is transmitted from the clerk terminal (30) in response to the product information request.

### TECHNICAL FIELD

The present invention relates to a point-of-sale (POS) terminal and a POS system.

### BACKGROUND ART

At checkout counters of retail stores, such as supermarkets, department stores, and convenience stores, a POS terminal reads a product identification label, such as a bar code attached to the packaging of a product, during check out. The POS terminal compares a product master, such as a price lookup (PLU) file in which the information of each product is registered, with information read from the product identification label in order to recognize the product. Therefore, when there is a product which has not been registered in the product master, it is difficult for the POS terminal to recognize the product.

The following Patent Document 1 discloses a method in which, when there is a product with a product code which has not been registered in a PLU file, the department and unit price of the input product, the image of the product captured by a scanner, and a product name detected from the image are provisionally registered in the PLU file and the image and the product name are used to facilitate a search for the provisionally registered product. The following Patent

Document 2 discloses a method in which, when an unregistered product is detected from a product master, the image of the product is captured at the same time as the bar code of the product is scanned and the captured product image facilitates the registration of the product in the product master. The following Patent Document 3 discloses a method in which, when product registration information corresponding to a product code has not been registered in a PLU file, a product image captured by a scanner and an input unit price are set for the product code and are additionally registered in the PLU file.

### RELATED DOCUMENT

### Patent Document

[Patent Document 1] Japanese Unexamined Patent Publication No. 2012-53710

[Patent Document 2] Japanese Examined Patent Publication No. 4-42718

[Patent Document 3] Japanese Unexamined Patent Publication No. 2006-277198

### DISCLOSURE OF THE INVENTION

According to the methods disclosed in the above-mentioned patent documents, it is possible to easily register a product (hereinafter, referred to as an unregistered product), which has not been registered in the product master that manages the product information, in the product master. However, when there is an unregistered product to be checked out and the unit price of the unregistered product has not been written to the packaging, it is difficult for a cash register clerk to recognize the unit price of the unregistered product, which results in the interruption of a registration operation. In this case, the cash register clerk goes to the point of sale, checks the unit price of the unregistered product, and resumes the registration operation.

The invention has been made in view of the above-mentioned problems and an object of the invention is to provide a technique that enables the cash register clerk to check the unit price of an unregistered product, without interrupting a registration operation.

Each aspect of the invention uses the following structures in order to solve the above-mentioned problems.

A first aspect relates to an information processing apparatus. An information processing apparatus according to the first aspect includes an image acquisition unit that acquires a product image of a product which is captured by an imaging unit and is registered as a checkout target, a request transmitting unit that transmits a product information request including the product image to a clerk terminal, and a response receiving unit that receives response information including sale price information of the product which is transmitted from the clerk terminal in response to the product information request.

A second aspect relates to an information processing system including a POS register apparatus and a POS management apparatus that implement an information processing apparatus. In the information processing system according to the second aspect, the POS register apparatus includes an image acquisition unit that acquires a product image of a product which is captured by an imaging unit and is registered as a checkout target and a request transmitting unit that transmits a product information request including the product image to the POS management apparatus. The POS management apparatus includes a request sending unit that sends the product information request to a clerk terminal, a response receiving unit that receives response information including sale price information of the product which is transmitted from the clerk terminal in response to the product information request, and a response transmitting unit that transmits the response information to the POS register apparatus.

A third aspect relates to an unregistered product lookup method that is performed by an information processing apparatus including an imaging unit which captures a product image of a product to be registered as a checkout target. The unregistered product lookup method according to the third aspect includes: acquiring the product image of the product which is captured by the imaging unit and is registered as the checkout target; transmitting a product information request including the product image to a clerk terminal; and receiving response information including sale price information of the product which is transmitted from the clerk terminal in response to the product information request.

A fourth aspect relates to an unregistered product lookup method that is performed by an information processing system including a POS register apparatus and at least one POS management apparatus which is provided between the POS register apparatus and each clerk terminal. The POS register apparatus and the POS management apparatus implement an information processing apparatus. The unregistered product lookup method according to the fourth aspect includes: causing the POS register apparatus to acquire a product image of a product which is captured by an imaging unit and is registered as a checkout target and to transmit a product information request including the product image to the POS management apparatus; and causing the POS management apparatus to send the product information request to the clerk terminal, to receive response information including sale price information of the product which is transmitted from the clerk terminal in response to the product information request, and to transmit the response information to the POS register apparatus.

Another aspect of the invention may provide a program that causes at least one computer (an information processing apparatus or a management apparatus) to implement the structure according to each of the above-mentioned aspects or a computer-readable recording medium having the program recorded thereon. The recording medium includes a non-transitory medium.

According to each of the above-mentioned aspects, the cash register clerk can check the unit price of an unregistered product, without interrupting a registration operation.

### BRIEF DESCRIPTION OF THE DRAWINGS

The above and other objects, features, and advantages will become more readily apparent from the following preferred embodiments and the following accompanying drawings.

FIG. 1 is a diagram illustrating an example of the outward appearance of a POS register apparatus according to a first embodiment.

FIG. 2 is a conceptual diagram illustrating an example of the hardware configuration of a POS register system according to the first embodiment.

FIG. 3 is a conceptual diagram illustrating an example of the processing structure of a portion of the POS register system according to the first embodiment.

FIG. 4 is a diagram illustrating an example of an unregistered product lookup screen and an example of the transitions of the screen to the unregistered product lookup screen in the first embodiment.

FIG. 5 is a flowchart illustrating the flow of a process up to an unregistered product lookup process is performed in the POS register apparatus.

FIG. 6 is a sequence diagram illustrating an example of the operation of the POS register system according to the first embodiment.

FIG. 7 is a diagram illustrating an example of the processing structure of a POS register system according to a second embodiment.

FIG. 8 is a diagram illustrating an example of an unregistered product lookup screen according to the second embodiment.

FIG. 9 is a diagram illustrating an example of information stored in an address table in the second embodiment.

FIG. 10 is a sequence diagram illustrating an example of the operation of the POS register system according to the second embodiment.

FIG. 11 is a diagram illustrating an example of the processing structure of a POS register system according to a third embodiment.

FIG. 12 is a sequence diagram illustrating an example of the operation of the POS register system according to the third embodiment.

FIG. 13 is a conceptual diagram illustrating an example of the structure of a POS system according to a modification.

### DESCRIPTION OF EMBODIMENTS

Hereinafter, embodiments of the invention will be described. The following embodiments are illustrative examples and the invention is not limited to the structure of each of the following embodiments.

### First Embodiment

[Structure of Device]

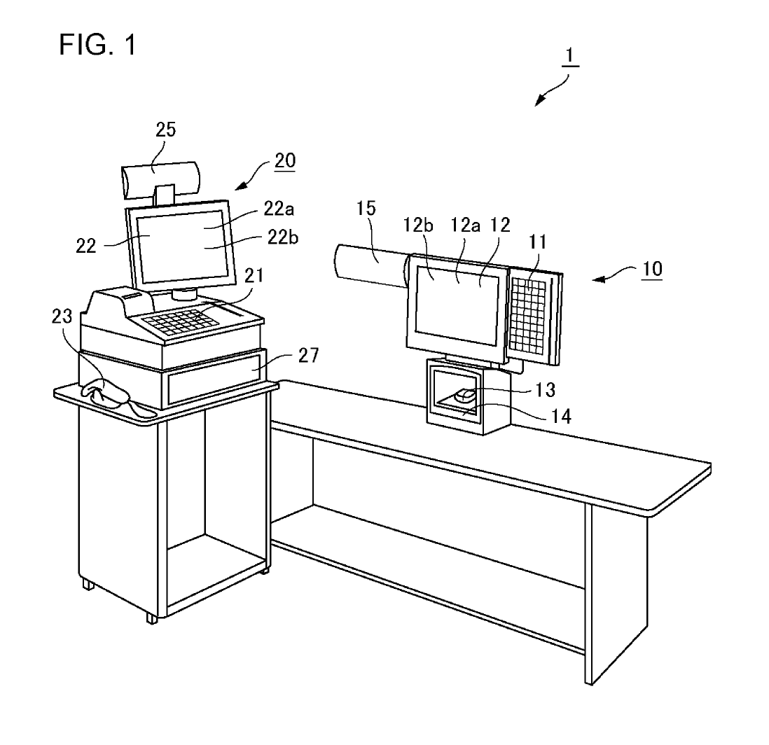

FIG. 1 is a diagram illustrating an example of the outward appearance of a POS register apparatus according to a first embodiment. As illustrated in FIG. 1, a POS register apparatus 1 according to the first embodiment includes a checker device 10 and a cashier device 20. The POS register apparatus 1, the checker device 10, and the cashier device 20 can also be referred to as a POS terminal.

The checker device 10 registers a product as a checkout target and transmits information about the product to be checked out to the cashier device 20. The checker device 10 includes, for example, a keyboard 11, a touch panel unit 12, a scanner device 13, and a display 15 for a customer. For example, information about the sale price of the product which is registered as the checkout target is displayed on the display 15 for a customer.

The touch panel unit 12 includes, for example, a display unit 12a, a touch panel 12b which receives a user operation, and a control unit. The touch panel unit 12 displays a screen corresponding to the received image data on the display unit 12a and senses touching on the touch panel 12b from the outside in order to obtain an input from the user (a clerk such as a cash register clerk). The touch panel unit 12 transmits the acquired input information. For example, the information about the product which is registered as a checkout target or an unregistered product lookup screen is displayed on the display unit 12a.

The unregistered product lookup screen means a screen which is used to check information about unregistered products. In each embodiment, the unregistered product means a product which has not been registered in a product information table stored in the POS register apparatus 1 or a product which has been registered in the product information table, but has not been registered in a checkout panel screen. The product information table stores product information including the code and name of each product, a department code which can specify the classification to which the product belongs, and sale price information. On the unregistered product lookup screen, the image of the unregistered product is captured and a product information request including the sale price information of the unregistered product is transmitted to a clerk terminal 30 of the sales clerk. Then, the sales clerk creates response information to the product information request with the clerk terminal 30 and returns the response information to the POS register apparatus 1. The POS register apparatus 1 displays the response information on the display unit 12a, using, for example, a pop-up message. Therefore, the cash register clerk can check the product information, such as sale price information required to register the unregistered product as a checkout target. These processes will be described in detail below.

The checkout panel screen is a screen which is used to register each product as a checkout target, without using a product identification label. Screen components corresponding to each product to be registered as a checkout target, without using a product identification label, are arranged on the checkout panel screen. In some cases, the product which is checked out with the checkout panel screen, without using a product identification label, is referred to as an unlabeled product. Therefore, the unlabeled products include not only a product which does not have a product identification label, but also a product which has a product identification label and is checked out using the checkout panel screen. When the screen component of the checkout panel screen is operated through the touch panel 12b, with the checkout panel screen displayed on the display unit 12a, the unlabeled product corresponding to the operated screen component is registered as a checkout target.

Here, the product identification label is a code symbol obtained by encoding a product code formed of characters, figures, and symbols which can specify each product and is represented by, for example, a one-dimensional bar code or a two-dimensional bar code. In this embodiment the product identification label can have any form as long as the product code can be extracted from the product identification label.

The scanner device 13 decodes the detected product identification label to extract the product code.

The product code is identification data which is predetermined in order to specify each product and is formed of, for example, characters, figures, and symbols. For example, a price lookup (PLU) code or a non-PLU code is used as the product code. In addition, for example, a Japan article number (JAN) code is used as the product code which is read using the product identification label.

The scanner device 13 detects the product identification label attached to the packaging of the product which passes over the reading window 14 and captures the image of the appearance of the product. The scanner device 13 can also be referred to as an imaging unit. Specifically, the scanner device 13 focuses light from the product as an optical image on an imaging element, such as a charge coupled device (CCD), through the reading window 14 and acquires image data of the product from an electric signal corresponding to the image. The scanner device 13 may detect the product identification label from the product image captured by the imaging element. In this case, the scanner device 13 has a function of automatically adjusting, for example, the focal length or the angle of field when the product image is captured and when the image of the product identification label is captured. In addition, the scanner device 13 may further include a laser scanner and may detect the product identification label using the laser scanner.

As such, the checker device 10 recognizes the product on the basis of the product code which is extracted from the product identification label by the scanner device 13, the product code which is acquired by the operation of the checkout panel screen, or the product code (in some cases, a department code) which is directly input by, for example, the keyboard 11, and registers the product as a checkout target.

The cashier device 20 performs a payment process for the product to be checked out. Basically, as described above, the checkout target is registered by the checker device 10. However, in some cases, the checkout target is additionally registered by the cashier device 20. In this case, the cashier device 20 recognizes the product on the basis of the product code which is extracted from the product identification label by a portable scanner 23, the product code which is acquired by the operation of the checkout panel screen, or the product code which is directly input through, for example, a keyboard 21 and additionally registers the product as a checkout target. Here, the sale price information and the department code which are notified by response information from the clerk terminal 30 are input through, for example, the keyboard 21 in order to register the unregistered product as a checkout target.

The cashier device 20 includes the keyboard 21, a touch panel unit 22, the portable scanner 23, a display 25 for a customer, and a cash drawer 27. The cash drawer 27 is used to store money used to pay for products, such as paper money, coins, and cash vouchers.

The touch panel unit 22 has the same structure as the touch panel unit 12. The touch panel unit 22 includes, for example, a display unit 22a and a touch panel 22b. For example, a screen related to a payment process for the product which is registered as a checkout target or a checkout panel screen is displayed on the display unit 22a. For example, the total amount and change are displayed on the display 25 for a customer.

The portable scanner 23 reads the product identification label attached to the packaging of the product and captures the image of the appearance of the product, similarly to the scanner device 13. The portable scanner 23 can also be referred to as an imaging unit. The portable scanner 23 preferably has the same structure as the scanner device 13. Therefore, the description thereof will not be repeated here.

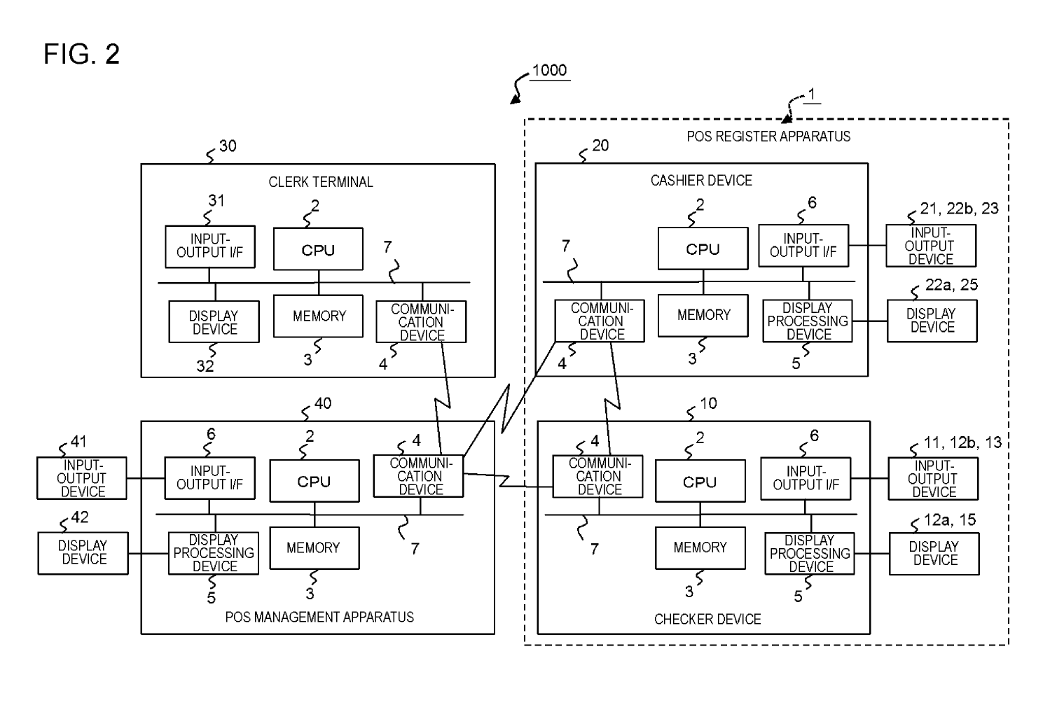

FIG. 2 is a conceptual diagram illustrating an example of the hardware configuration of a POS register system 1000 according to the first embodiment. As illustrated in FIG. 2, the checker device 10 includes, for example, a central processing unit (CPU) 2, a memory 3, a communication device 4, a display processing device 5, and an input-output interface (I/F) 6. These units are connected to, for example, a bus 7. The memory 3 is, for example, a random access memory (RAM), a read only memory (ROM), a hard disk, or a portable storage medium. The communication device 4 performs wireless or wired communication with other devices (for example, the cashier device 20 or the clerk terminal 30).

A display device is connected to the display processing device 5. The display processing device 5 transmits, to the display device, a screen display signal for displaying an optional screen according to the process performed by the CPU 2. The checker device 10 includes the display 15 for a customer and the display unit 12a of the touch panel unit 12 as the display device.

An input-output device is connected to the input-output I/F 6. The input-output I/F 6 outputs, for example, a voice to an output device and receives an input signal from an input device, according to the process performed by the CPU 2. The checker device 10 includes the keyboard 11, the touch panel 12b of the touch panel unit 12, and the scanner device 13 as the input-output device.

Similarly to the checker device 10, the cashier device 20 includes, for example, a CPU 2, a memory 3, a communication device 4, a display processing device 5, and an input-output I/F 6. The cashier device 20 includes the display 25 for a customer and the display unit 22a of the touch panel unit 22 as the display device. The cashier device 20 includes the keyboard 21, the touch panel 22b of the touch panel unit 22, and the portable scanner 23 as the input-output device.

The clerk terminal 30 includes, for example, a CPU 2, a memory 3, and a communication device 4. In addition, the clerk terminal 30 includes a display device 32, such as a display which displays information, and an input-output device 31, such as an operation key which operates the clerk terminal 30.

Similarly to the checker device 10, the POS management apparatus 40 includes, for example, a CPU 2, a memory 3, a communication device 4, a display processing device 5, and an input-output I/F 6. The POS management apparatus 40 may include a display device 42, such as a display, and an input-output device 41, such as a keyboard, in order to maintain the POS management apparatus 40.

This embodiment does not limit the hardware configuration of the checker device 10 and the cashier device 20. For example, the keyboards 11 and 21 may be replaced with a software keyboard. In addition, the displays 15 and 25 for a customer may be integrated into one display or they may be a display which displays the same content as the display unit 12a of the touch panel unit 12 and the display unit 22a of the touch panel unit 22.

[Processing Structure]

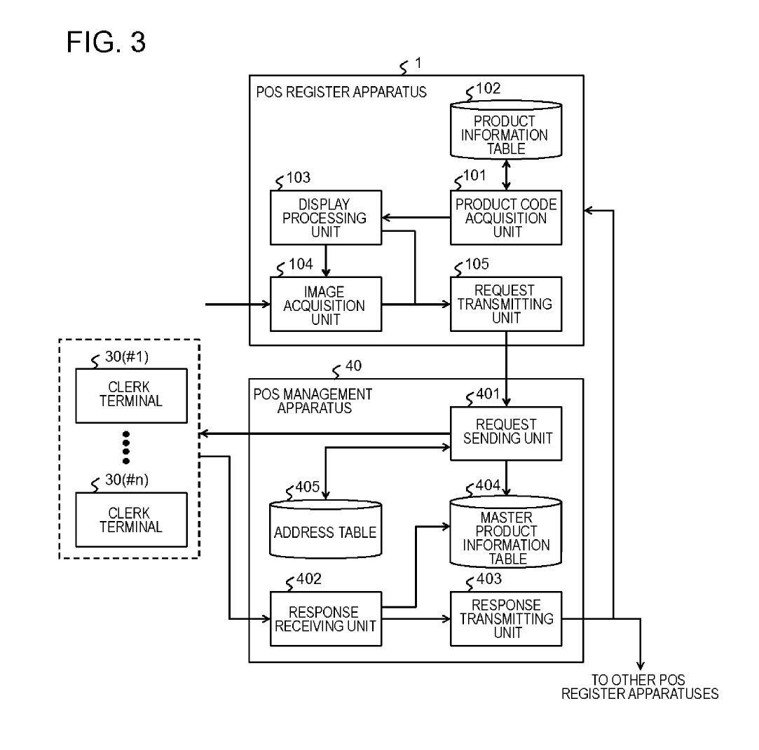

FIG. 3 is a conceptual diagram illustrating an example of the processing structure of a portion of the POS register system 1000 according to the first embodiment. In FIG. 3, the checker device 10 and the cashier device 20 form the POS register apparatus 1. Here, the processing structure included in the POS register apparatus 1 may be included in both or only one of the checker device 10 and the cashier device 20. FIG. 3 illustrates only the structure related to the unregistered product lookup screen. Therefore, the POS register apparatus 1 and the POS management apparatus 40 include a large number of processing units other than the processing units illustrated in the drawings.

<POS Register Apparatus>

The POS register apparatus 1 includes, for example, a product code acquisition unit 101, a product information table 102, a display processing unit 103, an image acquisition unit 104, and a request transmitting unit 105. The CPU 2 executes the program stored in the memory 3 to implement these processing units. The program may be installed from a portable recording medium, such as a compact disc (CD) or a memory card, or other devices and then stored in the memory 3.

The product code acquisition unit 101 acquires the product code from the product identification label. Specifically, the product code acquisition unit 101 decodes the product identification label which is detected by the imaging unit of the scanner device 13 or the portable scanner 23 and acquires the product code. That is, in each embodiment, the “acquisition of the product code” means reading the product code from, for example, the product identification label.

As described above, the product information table 102 stores product information including a product code, a product name, a department code which can specify the classification to which the product belongs, and sale price information. The product information is based on product information which is stored in a master product information table 404 of the POS management apparatus 40 which will be described below. The POS register apparatus 1 acquires the product information stored in the master product information table 404, which is distributed from the POS management apparatus 40, and stores the product information in the product information table 102.

The display processing unit 103 displays the unregistered product lookup screen on the display unit 12a or 22a. Specifically, the display processing unit 103 reads screen layout information of the unregistered product lookup screen which is stored in, for example, the memory 3 in advance, generates image data corresponding to the unregistered product lookup screen on the basis of the screen layout information, and transmits the image data to the display processing device 5. As a result, the unregistered product lookup screen is displayed on the display unit 12a or 22a under the control of the display processing device 5. Here, the screen layout information is information about, for example, the position or size of each screen component in the unregistered product lookup screen.

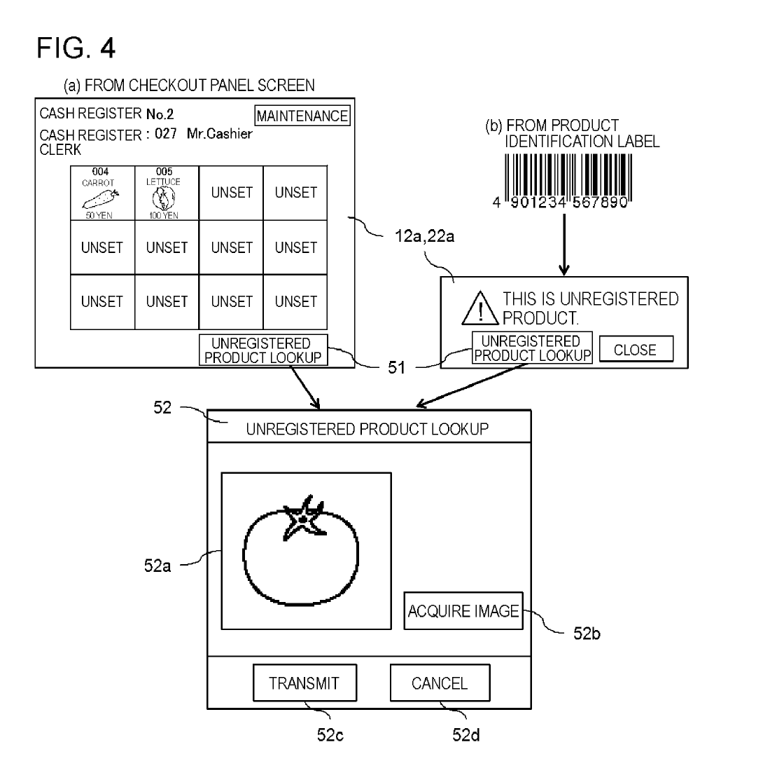

FIG. 4 is a diagram illustrating an example of the unregistered product lookup screen and an example of the transition of the screen to the unregistered product lookup screen in the first embodiment. In the example illustrated in FIG. 4, the checkout panel screen and a message window which displays a message “This is an unregistered product.” are illustrated as a transition source screen. When the product code which is read from the product identification label attached to the unregistered product is not included in the product information table 102, the POS register apparatus 1 displays this message window. For example, when an unregistered product lookup button 51 of the checkout panel screen or an unregistered product lookup button 51 of the message window illustrated in FIG. 4 is pressed, an unregistered product lookup screen 52 illustrated in FIG. 4 is displayed. The unregistered product lookup screen 52 includes, for example, an image display portion 52a, an image acquisition button 52b, a transmission button 52c, and a cancel button 52d.

In FIG. 4, when the image acquisition button 52b is pressed on the unregistered product lookup screen, the image acquisition unit 104 transmits a command to capture an image to the imaging unit such as the scanner device 13 and acquires the product image of the unregistered product captured by the imaging unit. In this case, as illustrated in FIG. 4, the product image may be displayed on the image display portion 52a such that the product image included in the product information request can be checked. Then, when the transmission button 52c is pressed, the product information request including the product image is transmitted to the POS management apparatus 40. When the reading result of the product identification label proves that the product is an unregistered product, the product identification code acquired from the product identification label may be inserted into the product information request.

The image acquisition unit 104 acquires the product image captured by the imaging unit of the scanner device 13 or the portable scanner 23. Here, the product image may be the image of the entire product or the image of a portion of the product. The image acquisition unit 104 temporarily stores the acquired product image in a storage area such as the memory 3.

The request transmitting unit 105 receives the product image of the unregistered product acquired by the image acquisition unit 104, generates a product information request including the product image, and transmits the product information request. The request transmitting unit 105 may generate the product information request as e-mail. As described above, when the product code is acquired from, for example, the image identification label attached to the unregistered product, the request transmitting unit 105 may insert the product code into the product information request.

<POS Management Apparatus>

As illustrated in FIG. 3, the POS management apparatus 40 includes, for example, a request sending unit 401, a response receiving unit 402, a response transmitting unit 403, a master product information table 404, and an address table 405. For example, the CPU 2 executes the program stored in the memory 3 to implement these processing units. The program may be installed from a portable recording medium, such as a compact disc (CD) or a memory card, or other devices and then stored in the memory 3.

The request sending unit 401 sends the product information request received from the request transmitting unit 105 to the clerk terminal 30 held by each clerk. Specifically, the POS management apparatus 40 includes the address table 405 which stores the address information of each clerk terminal and transmits the product information request to each clerk terminal 30 using the address information stored in the address table.

The response receiving unit 402 receives the response information created by the clerk from the clerk terminal 30. Here, the response information received by the response receiving unit 402 may be, for example, e-mail or a message text of any format.

The response transmitting unit 403 transmits the received response information to the POS register apparatus 1. Here, the response transmitting unit 403 may distribute the response information to the POS register apparatus 1 which has transmitted the product information request and other POS register apparatuses 1.

The master product information table 404 stores product information including the product code and name of each product, a department code which can specify the classification to which the product belongs, and sale price information. The department code indicates the category to which the product belongs, such as the vegetable department, the alcoholic liquor department, or the fresh fish department. The product information of each product stored in the master product information table 404 is the product information stored in the product information table 102 which is locally held by each POS register apparatus 1 communicably connected to the POS management apparatus 40 and is transmitted from the POS management apparatus 40 to each POS register apparatus 1. The master product information table 404 can also be referred to as a master product information storage unit.

The address table 405 stores the address information of each clerk terminal 30. The address information is preferably information which uniquely identifies the clerk terminal 30. For example, a mail address can be used as the address information.

<Clerk Terminal>

The clerk terminal 30 is a terminal held by a store clerk. The clerk terminal 30 may be a general-purpose terminal, such as a so-called mobile phone or personal digital assistant (PDA), or an independent terminal which is used only by the POS register system 1000. Each clerk checks, for example, the product image in the product information request transmitted from the POS register apparatus 1, using the display device 32 of the clerk terminal 30. Then, each clerk creates response information to the product information request, such as the sale price information of the product, using the input-output device 31, and transmits the response information to the POS management apparatus 40 through the communication device 4. The response information can include information related to the product, such as a department code indicating the classification of the product, a product name, and discount information, in addition to the sale price information of the product.

[Example of Operation]

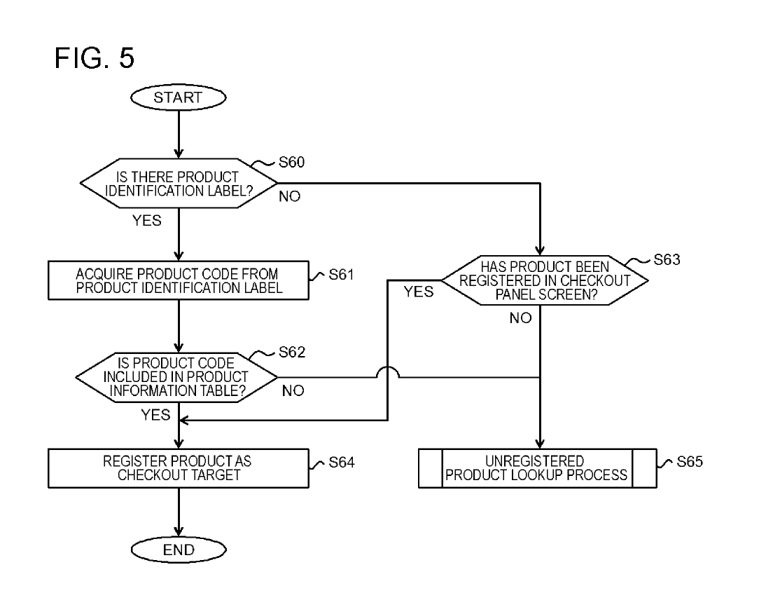

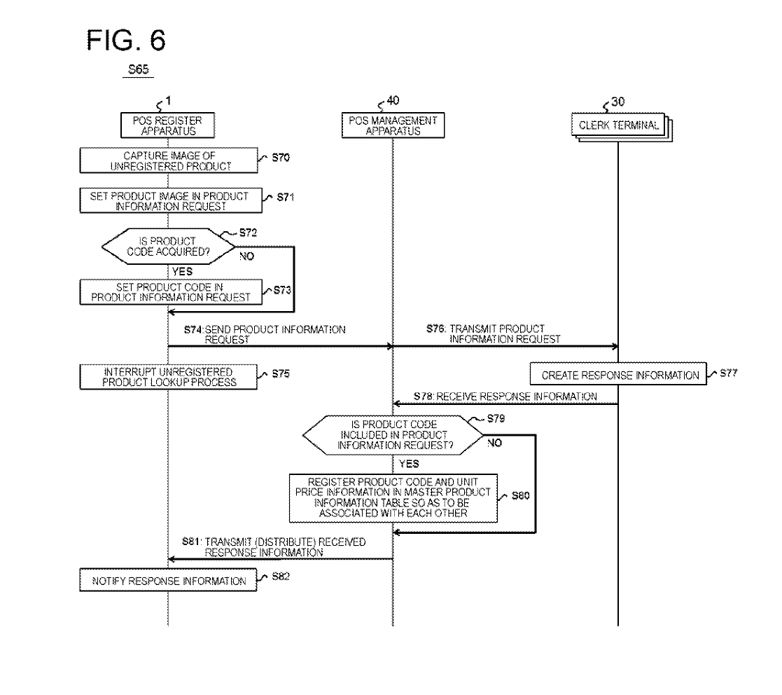

Next, an unregistered product lookup method according to the first embodiment will be described with reference to FIGS. 5 and 6. FIG. 5 is a flowchart illustrating the flow of a process up to an unregistered product lookup process in the POS register apparatus 1. FIG. 6 is a sequence diagram illustrating an example of the operation of the POS register system 1000 according to the first embodiment. The unregistered product lookup method according to the first embodiment is performed by the checker device 10 or the cashier device 20 forming the POS register apparatus 1 and the POS management apparatus 40 in the first embodiment.

First, the flow of the process up to the unregistered product lookup process will be described with reference to FIG. 5.

When the product to be checked out is registered, the cash register clerk checks whether the product identification label is attached to the product which is registered as a checkout target (S60). When the product identification label is attached to the product to be checked out (S60; YES), the POS register apparatus 1 acquires the product code from the product identification label. For example, the POS register apparatus 1 reads the product identification label using the scanner device 13 or the portable scanner 23 and acquires the product code from the product identification label (S61). Then, the POS register apparatus 1 checks whether the acquired product code has been registered in the product information table 102 (S62). When the acquired product code has been registered in the product information table 102 (S62; YES), the POS register apparatus 1 registers the product as a checkout target on the basis of the product information which is read from the product information table using the product code (S64). On the other hand, when the acquired product code has not been registered in the product information table 102 (S62; NO), the POS register apparatus 1 determines the product to be an unregistered product and displays the message window illustrated in FIG. 4. As in the example illustrated in FIG. 4, the cash register clerk presses the unregistered product lookup button 51 and instructs the POS register apparatus 1 to perform the unregistered product lookup process (S65).

On the other hand, when the product identification label is not attached to the product to be checked out (S60; NO), the cash register clerk registers the product as a checkout target with the checkout panel screen, without using the product identification label. In this case, the cash register clerk checks whether the product has been registered on the checkout panel screen (S63). The product has not been registered on the checkout panel screen when the product has not been registered in the product information table 102 and when the product has been registered in the product information table 102, but has not been set to the checkout panel screen. When the product has been registered on the checkout panel screen (S63; YES), the cash register clerk operates the screen component corresponding to the product on the checkout panel screen and instructs the POS register apparatus 1 to read the product information of the product from the product information table 102. The POS register apparatus 1 reads the product information from the product information table and registers the product as a checkout target, in response to the instruction (S64). On the other hand, when the product has not been registered on the checkout panel screen (S63; NO), the cash register clerk presses the unregistered product lookup button 51 and instructs the POS register apparatus 1 to perform the unregistered product lookup process, as in the example illustrated in FIG. 4 (S65).

Next, the flow of the unregistered product lookup process will be described.

As described above, when an unregistered product is included in the products to be checked out, for example, the cash register clerk performs an operation such that the unregistered product lookup screen is displayed as in the example illustrated in FIG. 4 and instructs the POS register apparatus 1 to capture the image of the unregistered product. For example, the cash register clerk presses the image acquisition button 52b illustrated in FIG. 4 using the touch panel 12b or 22b or the keyboard 11 or 21 of the POS register apparatus 1 to input the instruction.

The POS register apparatus 1 captures the image of the unregistered product using the scanner device 13 or the portable scanner 23 in response to the instruction (S70). The product image of the unregistered product is generated by the image capturing operation. The POS register apparatus 1 acquires the generated product image using the image acquisition unit 104.

The POS register apparatus 1 sets the product image in the product information request (S71). For example, the POS register apparatus 1 reads the product image which is temporarily stored in, for example, the memory 3 and sets the product image in the product information request.

The POS register apparatus 1 determines whether the product code is acquired from, for example, the product identification label attached to the unregistered product (S72). As described above, when the product code is acquired from the product identification label (S72; YES), the POS register apparatus 1 sets the product code in the product information request (S73). Then, the POS register apparatus 1 transmits the product information request including the product code and the product image to the POS management apparatus 40 (S74). On the other hand, when the product code is not acquired (S72; NO), the POS register apparatus 1 transmits the product information request which includes the product image and does not include the product code to the POS management apparatus 40 (S74). For example, the transmission button 52c illustrated in FIG. 4 is pressed to perform the above-mentioned steps (S71) to (S74).

Then, the POS register apparatus 1 interrupts the unregistered product lookup process until response information is received and the cash register clerk can use the functions used for the general registration operation (S75). Then, the cash register clerk can resume a registration operation of registering, as a checkout target, products other than the unregistered product corresponding to the transmitted product information request.

When receiving the product information request, the POS management apparatus 40 acquires the address information of the clerk terminal 30 with reference to the address table. The POS management apparatus 40 transmits the product information request to each clerk terminal 30 using the acquired address information (S76).

The clerk (for example, a sales clerk) confirms the product information request including the product image with the clerk terminal 30. Then, the sales clerk checks the product on the basis of the product image included in the product information request and creates response information including the sale price information about the product (S77). Here, the sales clerk may insert product information, such as the name or department code of the unregistered product, into the response information, in addition to the sale price information. Then, the sales clerk transmits the created response information from the clerk terminal 30 to the POS management apparatus 40.

The POS management apparatus 40 receives the response information including the sale price information from the clerk terminal 30 (S78). When the response information is received, the POS management apparatus 40 checks whether the product code is included in the product information request received from the POS register apparatus 1 (S79). When the product code is included in the product information request (S79; YES), the POS management apparatus 40 registers, in the master product information table, product information in which the product code included in the product information request and the sale price information included in the response information are associated with each other (S80). Then, the POS management apparatus 40 transmits the received response information to the POS register apparatus 1 (S81). Here, the POS management apparatus 40 may distribute the received response information to the POS register apparatuses 1 other than the POS register apparatus 1 which has transmitted the product information request. On the other hand, when the product code is not included in the product information request (S80; NO), the POS management apparatus 40 transmits or distributes the received response information to the POS register apparatus 1, without registering the product information in the master product information table (S81).

When receiving the response information from the POS management apparatus 40, the POS register apparatus 1 displays, for example, a pop-up message on the display unit 12a or 22a to notify the cash register clerk that the response information has been received (S82). In addition, the POS register apparatus 1 may display product information including response information, such as sale price information or a product name, on the screen, may output a printing instruction to a printing device (not illustrated), or may print a ledger sheet having the response information printed thereon. The cash register clerk can check the content of the notification, input information about the unregistered product to the POS register apparatus 1, and register the unregistered product as a checkout target.

[Operation and Effect of First Embodiment]

In the first embodiment, the scanner device 13 or the portable scanner 23 captures the image of the unregistered product which has not been registered in the master product information table and the product information request including the product image generated by the image capture is transmitted to the POS management apparatus 40. Then, the product information request is transmitted from the POS management apparatus 40 to the clerk terminal 30. The sales clerk creates the response information including the sale price information of the unregistered product on the basis of, for example, the product image in the product information request transmitted to the clerk terminal 30 and the response information is transmitted to the POS management apparatus 40. The response information is transmitted from the POS management apparatus 40 to the POS register apparatus 1. The response information transmitted to the POS register apparatus 1 is displayed on the POS register apparatus 1. As a result, the cash register clerk can check the product information related to the unregistered product such as the sale price information.

As such, according to the first embodiment, the cash register clerk can check, for example, the sale price information of the unregistered product with the POS register apparatus 1, without interrupting the operation and going to the point of sale. In addition, according to the first embodiment, until the response information is received from the sales clerk, the cash register clerk can check out other products and continuously perform the registration operation. Therefore, it is possible to shorten the waiting time of the customers.

In the first embodiment, when the product code corresponding to the unregistered product can be acquired from, for example, the product identification label, the product information in which the product code acquired from the identification label and the sale price information included in the response information from the sales clerk are associated with each other can be automatically registered in the master product information table 404. Therefore, it is possible to reduce the burden of the operation for registering the unregistered product in the master product information table 404. The POS management apparatus 40 can distribute the product information which is automatically registered in the master product information table 404 from the response transmitting unit 403 and reflect the product information in the product information table 102 of each POS register apparatus 1. According to this structure, in the subsequent operation, each POS register apparatus 1 can read the product code of the product as usual and register the product as a checkout target.

### Second Embodiment

In the POS register system 1000 according to the first embodiment, no condition is given when the address information is acquired from the address table 405. Therefore, the product information request about products other than the products handled by the clerk is likely to be transmitted to the clerk terminal 30.

Therefore, in a second embodiment, the transmission destination of product information request is specified on the basis of the product classification information of an unregistered product whose sale price information is desired to be known. The product classification information can be, for example, the department code of a product, a product name, or department information indicating the point of sale in the store. In many cases, the sales clerk takes charge of the point of sale corresponding to the department which is provided for each classification of the products. Therefore, it is possible to specify the sales clerk who takes charge of the point of sale including the unregistered product on the basis of information corresponding to the classification of the product. As a result, it is possible to prevent the product information request from being transmitted to the clerk terminal 30 of the clerk who does not take charge of the point of sale including the unregistered product. Hereinafter, a POS register system 1000 according to the second embodiment will be described with a focus on the difference from the first embodiment. In the following description, the description of the same content as that in the first embodiment will not be repeated.

[Processing Structure]

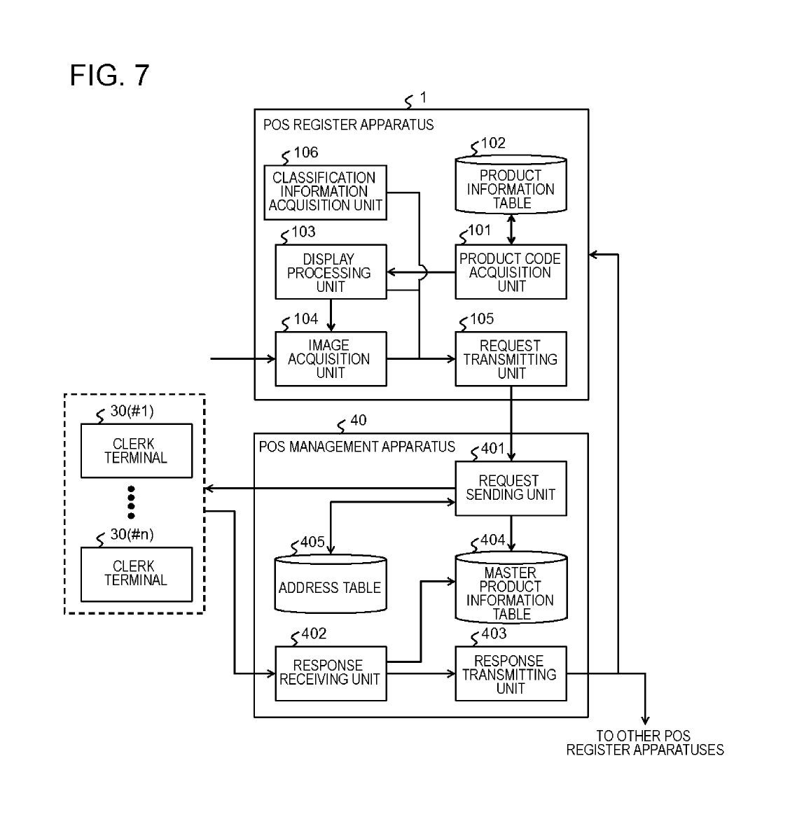

FIG. 7 is a diagram illustrating an example of the processing structure of the POS register system 1000 according to the second embodiment. The POS register apparatus 1 further includes a classification information acquisition unit 106, as compared to the first embodiment.

The classification information acquisition unit 106 acquires the product classification information of the unregistered product to be processed. Specifically, the classification information acquisition unit 106 receives an input from the cash register clerk through, for example, a touch panel 12b or 22b or a keyboard 11 or 21 and acquires the product classification information of the unregistered product. In addition, the POS register apparatus 1 may further include a table in which feature amounts extracted from the image of each product and the product classification information are associated with each other and acquire the product classification information on the basis of the table. In this case, the classification information acquisition unit 106 can match the feature amounts which are extracted from the product image acquired by an imaging unit with the feature amounts in the table to acquire the associated product classification information.

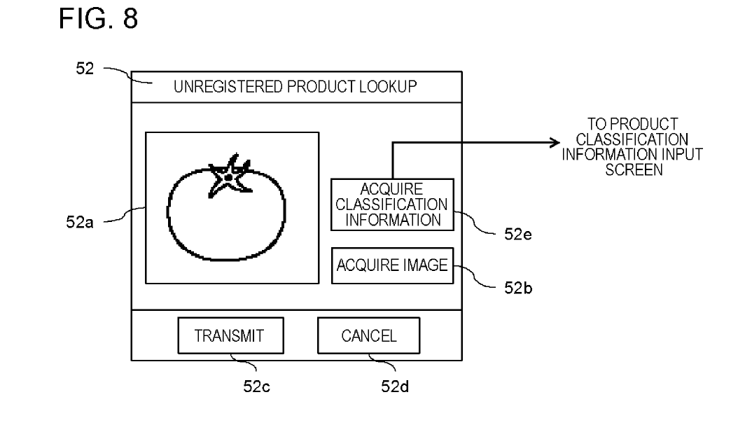

FIG. 8 is a diagram illustrating an example of an unregistered product lookup screen in the second embodiment. In this embodiment, the unregistered product lookup screen further includes a classification information input button 52e, as compared to the first embodiment. In the example illustrated in FIG. 8, the classification information input button 52e is pressed to display a product classification information input screen (not illustrated). As described above, the classification information acquisition unit 106 acquires the product classification information input by the cash register clerk through the input screen.

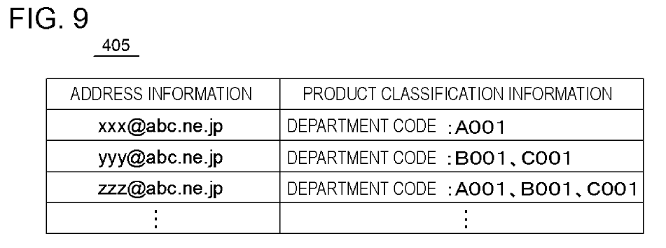

In this embodiment, an address table 405 stores the address information of the clerk terminal 30 and the product classification information so as to be associated with each other. The address table 405 stores, for example, the information illustrated in FIG. 9. FIG. 9 illustrates an example in which the product classification information is a department code. However, as described above, the product classification information is not limited thereto. In addition, FIG. 9 illustrates an example in which the address information is a mail address. However, the address information is not limited thereto as long as it can identify the address.

[Example of Operation]

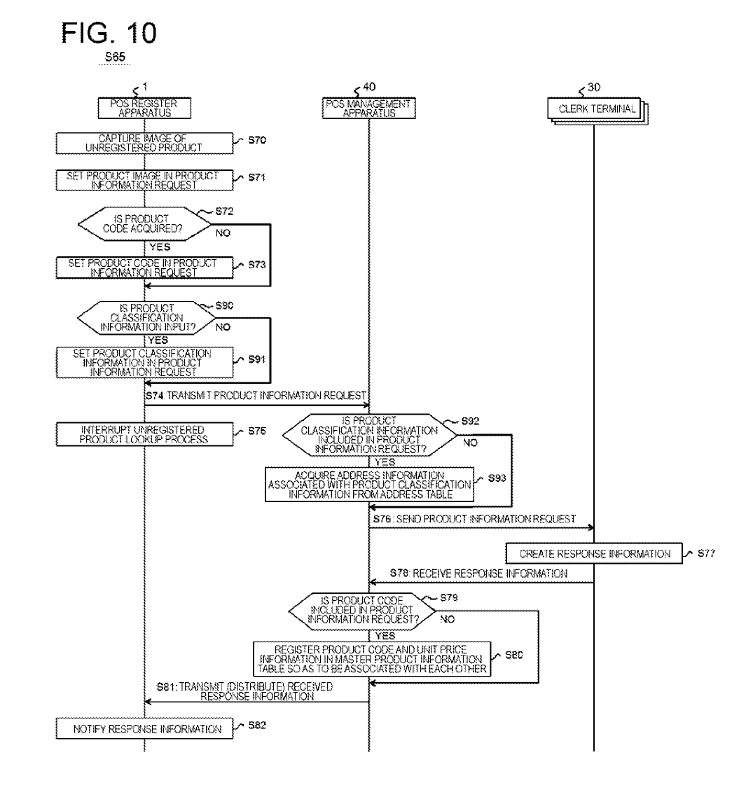

Next, an unregistered product lookup method according to the second embodiment will be described with reference to FIG. 10. FIG. 10 is a sequence diagram illustrating an example of the operation of the POS register system 1000 according to the second embodiment. In FIG. 10, the same steps as those in the example of the operation according to the first embodiment are denoted by the same reference numerals as those in FIG. 6. The unregistered product lookup method according to the second embodiment differs from that according to the first embodiment in Steps S90 to S93. Therefore, only these steps will be described below.

In FIG. 10, the POS register apparatus 1 determines whether the product code is acquired from the product identification label attached to the unregistered product (S72) and checks whether the product classification information is input (S90). When the product classification information is input (S90; YES), the POS register apparatus 1 further sets the input product classification information in the product information request (S91) and transmits the product information request to the POS management apparatus 40 (S74). On the other hand, when the product classification information is not input (S90; NO), the POS register apparatus 1 transmits the product information request to the POS management apparatus 40 (S74).

The POS management apparatus 40 determines whether the product classification information is included in the product information request (S92). When the product classification information is included in the product information request (S92; YES), the POS management apparatus 40 acquires the product classification information from the product information request and acquires the address information associated with the acquired product classification information from the address table 405 (S93). Then, the POS management apparatus 40 transmits the product information request to the clerk terminal 30 corresponding to the acquired address information (S76). On the other hand, when the product classification information is not included in the product information request (S92; NO), the POS management apparatus 40 acquires the address information, without depending on the product classification information, and transmits the product information request to the clerk terminal 30, similarly to the first embodiment (S76).

[Operation and Effect of Second Embodiment]

In the second embodiment, the product classification information is input from an input device, such as the touch panel 12b or 22b or the keyboard 11 or 21, in the POS register apparatus 1 and is set in the product information request. The POS management apparatus 40 extracts the address information which is stored so as to be associated with the product classification information and transmits the product information request only to the clerk terminal 30 indicated by the extracted address information. Therefore, according to the second embodiment, it is possible to prevent the clerks other than the clerk who takes charge of the unregistered product from unnecessarily checking the product information request. It is possible to transmit the product information request only to the clerk who takes charge of the unregistered product related to the product information request. The POS register apparatus 1 can receive accurate response information.

### Third Embodiment

In the first and second embodiments, the POS management apparatus 40 receives the product information request from the POS register apparatus 1 and transmits the product information request to the clerk terminal 30. Here, the following structure is considered: for example, a mail server of a communications company which is generally used to transmit and receive mail is used to transmit and receive the product information request, instead of the POS management apparatus 40.

In third embodiment, the product information request is transmitted to the clerk terminal 30, without passing through the POS management apparatus 40. Hereinafter, a POS register apparatus 1 according to the third embodiment will be described with a focus on the difference from the first and second embodiments. In the following description, the description of the same content as that in the first and second embodiments will not be repeated.

[Processing Structure]

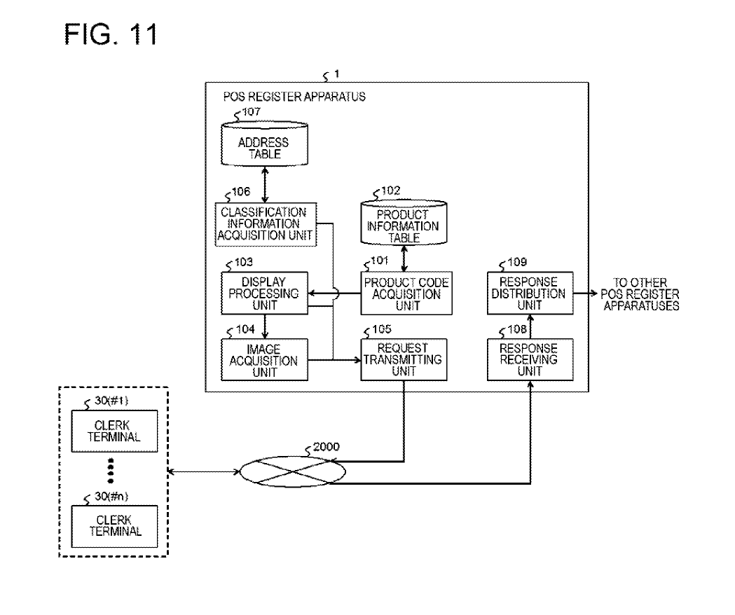

FIG. 11 is a diagram illustrating an example of the processing structure of a POS register system 1000 according to the third embodiment. In the first and second embodiments, the POS management apparatus 40 transmits the product information request. However, in this embodiment, for example, the product information request is transmitted by a mail server (not illustrated) of a communications company which is connected to a network 2000 such as the Internet. Therefore, the POS register apparatus 1 according to the third embodiment further includes an address table 107, a response receiving unit 108, and a response distribution unit 109, as compared to the second embodiment. For example, a CPU 2 executes the program stored in a memory 3 to implement the address table 107, the response receiving unit 108, and the response distribution unit 109.

The address table 107 has the same function as the address table 405 of the POS management apparatus 40 according to the second embodiment and stores the address information of the clerk terminal 30 and product classification information so as to be associated with each other.

The response receiving unit 108 has the same function as the response receiving unit 402 of the POS management apparatus 40 according to the second embodiment and receives the response information created by the clerk from the clerk terminal 30. Here, the response information received by the response receiving unit 108 may be, for example, e-mail or a message text of any format.

The response distribution unit 109 has the same function as the response transmitting unit 403 of the POS management apparatus 40 according to the second embodiment and distributes the response information received by the response receiving unit 108 to other POS register apparatuses 1.

[Example of Operation]

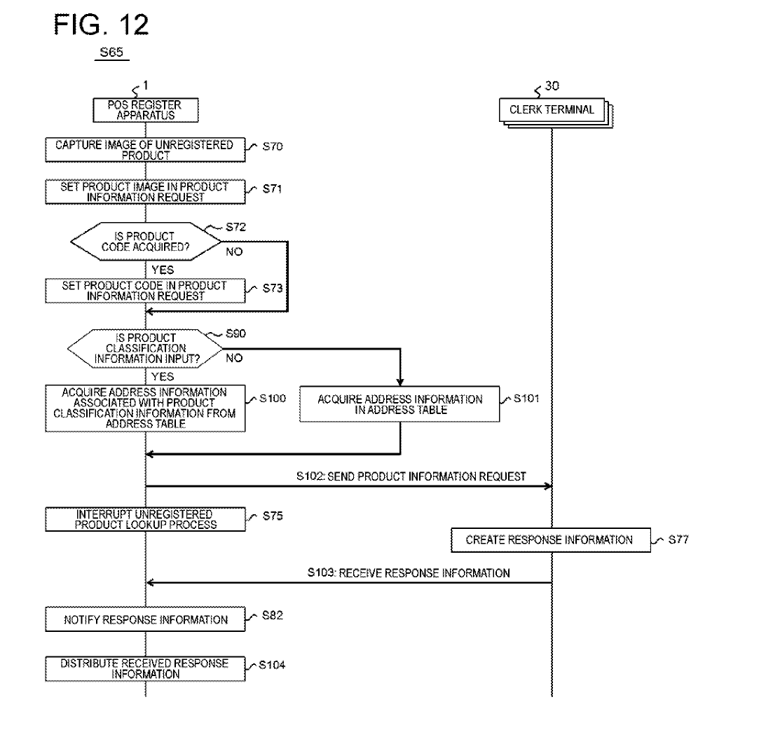

Next, an unregistered product lookup method according to the third embodiment will be described with reference to FIG. 12. FIG. 12 is a sequence diagram illustrating an example of the operation of the POS register system 1000 according to the third embodiment. In FIG. 12, the same steps as those in the example of the operation according to the second embodiment are denoted by the same reference numerals as those in FIGS. 6 and 10. The unregistered product lookup method according to the third embodiment differs from those according to the first and second embodiments in Steps S100 to S104. Therefore, only these steps will be described below.

In FIG. 12, the POS register apparatus 1 determines whether a product code is acquired from a product identification label attached to an unregistered product (S72) and checks whether product classification information is input (S90). When the product classification information is input (S90; YES), the POS register apparatus 1 acquires the address information which is associated with the product classification information from the address table 107 (S100). Then, the POS register apparatus 1 transmits the product information request to the clerk terminal 30 corresponding to the acquired address information (S102). On the other hand, when the product classification information is not input (S90; NO), the POS register apparatus 1 acquires the address information in the address table, without narrowing the conditions of the acquired address information (S101). Then, the POS register apparatus 1 transmits the product information request to the clerk terminal 30 corresponding to the address information which has been acquired without narrowing the conditions (S102).

The POS register apparatus 1 receives response information including sale price information from the clerk terminal 30 (S103). The POS register apparatus 1 can display, for example, a pop-up message on a display unit 12a or 22a to notify the cash register clerk that the response information has been received (S82). In addition, the POS register apparatus 1 can distribute the received response information to other POS register apparatuses 1 (S104).

[Operation and Effect of Third Embodiment]

In the third embodiment, for example, the product information request is transmitted from the POS register apparatus 1 to the clerk terminal 30 through the mail server of the communications company. In this embodiment, the POS register apparatus 1 further includes the response receiving unit 108. Therefore, the POS register apparatus 1 can receive the response information created by the clerk terminal 30. Since the POS register apparatus 1 further includes the response distribution unit 109, the received response information can be distributed to other POS register apparatuses. Therefore, it is possible to obtain the same effect as that in the first embodiment. In this embodiment, the POS register apparatus 1 further includes the address table 107 which stores the same information as the address table 405 according to the second embodiment. Therefore, it is possible to use the address information associated with the product classification information and to obtain the same effect as that in the second embodiment.

This embodiment has the structure based on the second embodiment. However, the invention is not limited thereto and may have the structure based on the first embodiment.

[Modifications]

In each of the above-described embodiments, the POS register apparatus 1 includes the checker device 10 and the cashier device 20. However, the POS register apparatus 1 may include only the cashier device 20. In each of the above-described embodiments, the unregistered product lookup screen can be displayed by the checker device 10 and the cashier device 20. However, the unregistered product lookup screen may be displayed by only one of the checker device 10 and the cashier device 20.

In each of the above-described embodiments, each processing unit of the POS register apparatus 1 may be included in both the checker device 10 and the cashier device 20 or it may be included in only one of the checker device 10 and the cashier device 20.

In each of the above-described embodiments, the portable scanner 23 of the cashier device 20 also captures the product image. However, only the scanner device 13 of the checker device 10 may capture the product image.

The POS register apparatus 1 and the POS management apparatus 40 according to each of the above-described embodiments may be a POS system including a server apparatus and a store terminal.

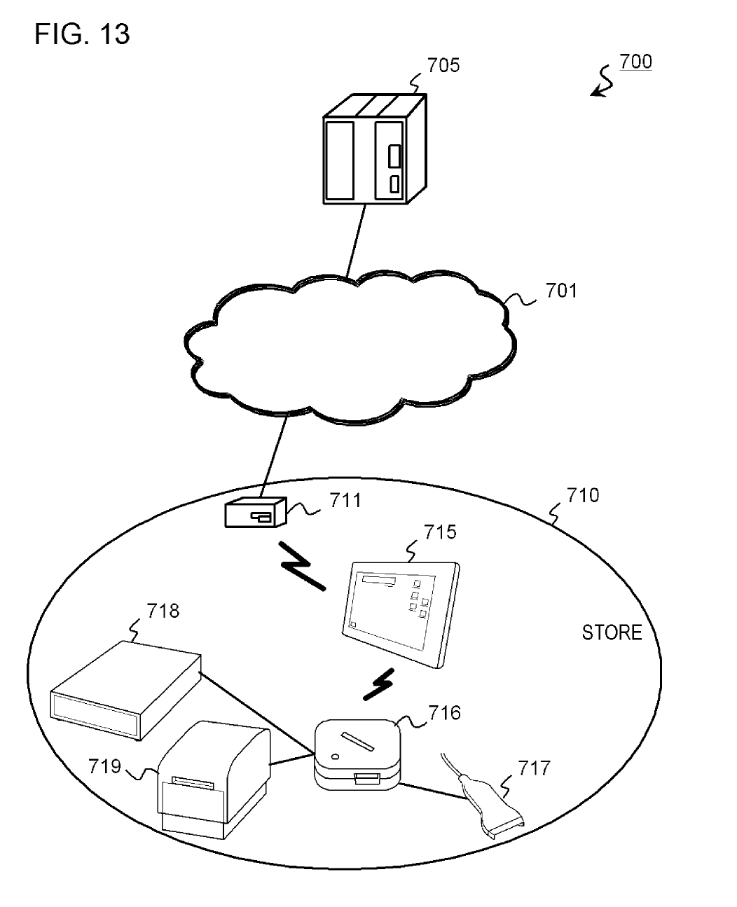

FIG. 13 is a conceptual diagram illustrating an example of the structure of a POS system 700 according to a modification.

The POS system 700 includes a server apparatus 705 and a store-side structure 710. The server apparatus 705 and the store-side structure 710 are connected by a communication network 701 so as to communicate with each other. The communication network 701 is, for example, a public network, such as the Internet, a wide area network (WAN), a local area network (LAN), or a wireless communication network. The form of the communication network 701 is not particularly limited.

The store-side structure 710 includes, for example, a communication relay device 711, a store terminal 715, a stand 716, a portable scanner 717, a cash drawer 718, and a receipt printer 719. The stand 716 is a device for connecting the store terminal 715 and other devices (the portable scanner 717, the cash drawer 718, and the receipt printer 719) so as to communicate with each other. The store terminal 715 and the stand 716 are connected to each other by short-range wireless communication, such as Bluetooth (registered trademark) or infrared communication, or a wireless LAN. The stand 716 and other devices are connected to each other by various communication lines or wirelessly. The communication relay device 711 connects the store terminal 715 to the communication network 701 such that the store terminal 715 and the server apparatus 705 can communicate with each other. In addition, a communication method between these nodes is not particularly limited. The communication relay device 711 may not be provided and the store terminal 715 may be connected to the communication network 701 by, for example, a 3G line through, for example, a wireless base station, without passing through the communication relay device 711.

The store terminal 715 is a general-purpose computer, such as a personal computer (PC), a notebook PC, a tablet terminal, or a smart phone and exchanges data with the server apparatus 705 to form a user interface of the POS register apparatus 1. The server apparatus 705 is a general server computer and is configured as, for example, a WEB server or an application server.

In the aspect in which the POS register apparatus 1 and the POS management apparatus 40 according to the above-described embodiments form the POS system 700, each of the above-mentioned processing units may be implemented by any of the server apparatus 705 and the store terminal 715 as long as it can be implemented. For example, when a WEB system is used as the interface between the server apparatus 705 and the store terminal 715, all of the processing units of the POS register apparatus 1 and the POS management apparatus 40 may be implemented by the server apparatus 705 and the store terminal 715 may operate as a simple display unit. In addition, all of the processing units of the POS management apparatus 40 may be implemented by the server apparatus 705 and all of the processing units of the POS register apparatus 1 may be implemented by the store terminal 715. In the POS register apparatus 1, some of the processing units may be implemented by the server apparatus 705 and the other processing units may be implemented by the store terminal 715. For example, the product information table 102 or the address table 107 may be implemented by the server apparatus 705 and the other processing units may be implemented by the store terminal 715.

As such, the information processing apparatus according to the invention may be implemented by a plurality of devices (a plurality of computers or a plurality of devices including CPUs). The information processing apparatus according to the invention may be implemented by a combination of the checker device 10 and the cashier device 20 according to the above-described embodiments or it may be implemented by a combination of the server apparatus 705 and the store terminal 715 according to this modification. Of course, the information processing apparatus according to the invention maybe implemented only by the cashier device 20 according to the above-described embodiments or it may be implemented only by the server apparatus 705 or the store terminal 715 according to the modification.

In the plurality of flowcharts and sequence diagrams used in the above description, a plurality of steps (processes) are sequentially described. However, the execution order of the steps in each embodiment is not limited to the above-mentioned order. In each embodiment, the order of the steps illustrated in the drawings can be changed in the range in which the content is consistent. In addition, the above-described embodiments and modifications can be combined with each other in the range in which the content is consistent.

Priority is claimed on Japanese Patent Application No. 2012-180248, filed on Aug. 15, 2012, the content of which is incorporated herein by reference.

1. An information processing apparatus comprising:
an image acquisition unit that acquires a product image of a product which is captured by an imaging unit and is registered as a checkout target;
a request transmitting unit that transmits a product information request including the product image to a clerk terminal; and
a response receiving unit that receives response information including sale price information of the product which is transmitted from the clerk terminal in response to the product information request.

2. The information processing apparatus according to claim 1, further comprising:
an address table that stores address information of the clerk terminal so as to be associated with each product classification information,
wherein the request transmitting unit acquires the product classification information of the product corresponding to the product image, extracts the address information corresponding to the acquired product classification information from the address table, and transmits the product information request using the extracted address information.

3. The information processing apparatus according to claim 1, further comprising:
a response distribution unit that distributes the response information to other information processing apparatuses.

4. An information processing system comprising:
a point-of-sale (POS) register apparatus and a POS management apparatus that implement an information processing apparatus,
wherein the POS register apparatus includes:
an image acquisition unit that acquires a product image of a product which is captured by an imaging unit and is registered as a checkout target; and
a request transmitting unit that transmits a product information request including the product image to the POS management apparatus, and
the POS management apparatus includes:
a request sending unit that sends the product information request to a clerk terminal;
a response receiving unit that receives response information including sale price information of the product which is transmitted from the clerk terminal in response to the product information request; and
a response transmitting unit that transmits the response information to the POS register apparatus.

5. The information processing system according to claim 4,
wherein the request transmitting unit acquires the product code from a product identification label including a product code which can specify a product and transmits the product information request including the acquired product code and the product image, and
the POS management apparatus further includes a master product information table in which product information including the product code and the sale price information is registered and a product information registration unit that registers the sale price information and the product code received from the request transmitting unit in the master product information table so as to be associated with each other.

6. The information processing system according to claim 4,
wherein the request transmitting unit acquires product classification information of the product corresponding to the product image and transmits the product information request including the acquired product classification information and the product image,
the POS management apparatus further includes an address table that stores address information of the clerk terminal so as to be associated with each product classification information, and
the request sending unit extracts, from the address table, the address information corresponding to the product classification information received from the request transmitting unit and sends the product information request using the extracted address information.

7. The information processing system according to claim 4,
wherein the response transmitting unit transmits the response information to other POS register apparatuses.

8. An unregistered product lookup method comprising:
causing an information processing apparatus to acquire a product image of a product which is captured by an imaging unit and is registered as a checkout target;
causing the information processing apparatus to transmit a product information request including the product image to a clerk terminal; and
causing the information processing apparatus to receive response information including sale price information of the product which is transmitted from the clerk terminal in response to the product information request.

9. The unregistered product lookup method according to claim 8,
wherein the information processing apparatus further includes an address table that stores address information of the clerk terminal so as to be associated with each product classification information, and
the information processing apparatus acquires the product classification information of the product corresponding to the product image, extracts the address information corresponding to the acquired product classification information from the address table, and transmits the product information request using the extracted address information.

10. The unregistered product lookup method according to claim 8, further comprising:
causing the information processing apparatus to distribute the response information to other information processing apparatuses.

11. An unregistered product lookup method which is performed by an information processing system including a point-of-sale (POS) register apparatus and a POS management apparatus that implement the information processing apparatus according to claim 1, the method comprising:
causing the POS register apparatus to acquire a product image of a product which is captured by an imaging unit and is registered as a checkout target and to transmit a product information request including the product image to the POS management apparatus; and
causing the POS management apparatus to send the product information request to a clerk terminal, to receive response information including sale price information of the product which is sent from the clerk terminal in response to the product information request, and to transmit the response information to the POS register apparatus.

12. The unregistered product lookup method according to claim 11, further comprising:
causing the POS register apparatus to acquire the product code from a product identification label including a product code which can specify a product and to transmit the product information request including the acquired product code and the product image; and
causing the POS management apparatus, which includes a master product information table in which product information including the product code and the sale price information is registered, to register the sale price information and the product code received from the POS register apparatus in the master product information table so as to be associated with each other.

13. The unregistered product lookup method according to claim 11, further comprising:
causing the POS register apparatus to acquire product classification information of the product corresponding to the product image and to transmit the product information request including the acquired product classification information and the product image; and
causing the POS management apparatus, which further includes an address table that stores address information of the clerk terminal so as to be associated with each product classification information, to extract, from the address table, the address information corresponding to the product classification information received from the POS register apparatus and to send the product information request using the extracted address information.

14. The unregistered product lookup method according to claim 11, further comprising:
causing the POS management apparatus to transmit the response information to other POS register apparatuses.

15. A non-transitory computer readable storage medium storing an unregistered product lookup program that causes an information processing apparatus to function as:
an image acquisition unit that acquires a product image of a product which is captured by an imaging unit and is registered as a checkout target;
a request transmitting unit that transmits a product information request including the product image to a clerk terminal; and
a response receiving unit that receives response information including sale price information of the product which is transmitted from the clerk terminal in response to the product information request.

16. A non-transitory computer readable storage medium storing an unregistered product lookup program that implements an information processing system including a point-of-sale (POS) register apparatus and a POS management apparatus that implement an information processing apparatus,
wherein the unregistered product lookup program causes the POS register apparatus to function as:
an image acquisition unit that acquires a product image of a product which is captured by an imaging unit and is registered as a checkout target; and a request transmitting unit that transmits a product information request including the product image to the POS management apparatus, and
the unregistered product lookup program causes the POS management apparatus to function as:
a request sending unit that sends the product information request to a clerk terminal;
a response receiving unit that receives response information including sale price information of the product which is transmitted from the clerk terminal in response to the product information request; and
a response transmitting unit that transmits the response information to the POS register apparatus.
